(19) United States
(12) Patent Application Publication
(10) Pub. No.: US 2003/0081800 A1
(43) Pub. Date: May 1, 2003

(54) Flat panel sound radiator with supported exciter and compliant surround

(76) Inventors: Michael Klasco, Berkley, CA (US); Pablo Tobiano, San Marino, CA (US); Carlos Go, San Francisco, CA (US)

Correspondence Address: Womble Carlyle Sandridge & Rice, PLLC, P.O. Box 7037, Atlanta, GA, 30357-0037, US

(21) Appl. No.: 10/003,929

(22) Filed: Oct. 31, 2001

(51) Int. Cl. H04R 25/00; H04R 1/00; H04R 9/06; H04R 11/02

(52) U.S. Cl. 381/152; 381/431

(57) ABSTRACT

An improved flat panel sound radiator assembly is provided for reproducing high quality sound at volume levels substantially higher than existing flat panel sound radiator systems. The assembly includes a flat panel radiator having a core sandwiched between facing skins. The core, which preferably is a honeycomb core, and the skins are made of materials that result in a substantially enhanced signal-to-noise ratio and enhanced bass response when reproducing sound. The flat panel radiator is disposed within a frame and the peripheral edges of the radiator are movably coupled to the frame with a compliant surround. An exciter, which may be a traditional magnet structure, is mounted on and supported by a bridge structure spaced from the inside face of the radiator and is coupled to the radiator only through a voice coil assembly. In use, the radiator produces sound through distributed mode reproduction below a sound level threshold. However, when large vibrations are imparted to the radiator corresponding to high volume level or deep bass sounds, the compliant surround accommodates pistonic motion of the entire radiator panel to produce these sounds in a substantially pistonic mode.

### TECHNICAL FIELD

This invention relates generally to audio transducers and more particularly to flat panel sound radiators wherein a flat panel rather than a traditional cone is vibrated by a transducer motor or exciter to reproduce an audio program.

### BACKGROUND

In a traditional cone-type speaker, a cone made of paper, plastic, aluminum, or another appropriate material is mounted and supported in a rigid frame by a flexible surround that extends about the periphery of the cone and a circumferentially corrugated spider that extends about the cone near its apex. The cone is the acoustic radiating surface, which couples the mechanical forces generated by the interaction of the currents flowing through the voice coil in the presence of a strong magnetic field in a “voice coil gap.” The voice coil is an assembly of wire helically wound onto a hollow cylindrical bobbin. The bobbin is attached to the cone at its apex and extends into the annular gap of a magnet motor assembly mounted to the back of the frame. Thus, the cone plus voice coil assembly may move freely in the axial direction, but is constrained otherwise.

The voice coil is coupled to an audio amplifier, which feeds the voice coil with alternating electrical current with the level and temporal characteristics analogous to the sound that will be reproduced. These currents, in turn, generate a force acting on (accelerating) the moving mass, according to the equation F=BLI, where F is the force, B is the magnetic flux around the coil, L is the length of the voice coil wire, and I the current. The force generates axial acceleration of the voice coil within the magnetic field. The voice coil bobbin passes these forces to the cone apex, which causes the cone to vibrate, thereby reproducing the original audio program and projecting it into the listening area.

In the case of a low frequency speaker or woofer, the cone moves as a piston for sound energy with wavelengths greater than the diameter of the cone. This typically corresponds to audio frequencies less than about 1 to 2 KHz. For audio frequencies higher than this (i.e. beyond the pistonic operational range of the speaker), the sound reproduction of the woofer becomes rough and noisy. This is because such frequencies are reproduced in the woofer not by pistonic movement but rather by a flexing and rippling of the cone from its apex to its periphery. Under these circumstances, the acoustical characteristics of the cone material itself, which determine the cone's “self-noise,” contribute significantly to the sound reproduction coloration. By way of illustration of self-noise, a thin sheet of aluminum waved rapidly in the air causes rippling and flexing in the sheet, which results in the emission of an audible rattling or “thunder” noise. This is the self-noise of the sheet. Even paper cones emit a “cone cry” when flexed and rippled. In contrast, a silk scarf waved rapidly in the air produces virtually no self-noise.

Thus, the physical properties of the material from which a speaker cone is made can significantly affect the self-noise of the speaker. To avoid the flexing motion that excites self-noise in woofers, most traditional 2 and 3-way loudspeaker systems utilize an electrical or electronic “crossover” that includes a low pass filter, which allows only frequencies with longer wavelengths to pass through to the woofer. Higher frequencies are directed by the crossover to smaller mid-range speakers and/or tweeters of the system, which reproduce the midrange and high frequency content of the audio program.

Similar considerations apply to tweeters and other higher frequency transducers used in modern loudspeaker systems. Many such transducers utilize small (typically about 1 inch in diameter) domes made of silk, polycarbonate or Mylar (plastic), or metal (aluminum or titanium). If the dome of an aluminum or polycarbonate dome tweeter is flexed by being poked with a finger, the dome's self-noise can be audibly observed. The dome will emit a crackling noise. Such domes may therefore be said to have a relatively high self-noise. In contrast, if the diaphragm of a silk dome tweeter is poked with a finger, it will flex relatively silently. Silk dome tweeters may be said to have low self-noise.

The self-noise of a tweeter also can be activated by the vibrational flexing induced in the dome during the reproduction of an audio program. However, since the self-noise typically is only audible for a small portion of the tweeter's upper frequency response range, it usually is a secondary consideration when designing traditional loudspeaker systems. Generally speaking, higher quality loudspeaker systems are designed to minimize the self-noise of its various speakers in order to reproduce the original audio program material as accurately and clearly as possible without introducing unrelated modulations, spurious resonances, and other sounds characteristic of self-noise (i.e. they are designed to exhibit high signal-to-noise ratios).

It will be obvious from the forgoing discussion that the physical and material properties of the materials from which speaker cones and domes are fabricated determine, to a large degree, the self-noise of the speaker. Generally speaking, such characteristics include the stiffness of the material, its tensile strength, thickness, density, the material's Young's Modulus (E), as well as its internal damping, among other factors. Another key characteristic for diaphragm materials is the speed of sound in the material. In homogenous materials, the speed of sound equals the square root of the ratio of Young's modulus to the density. The damping may be measured by a “loss factor” (or μ), or the “tan delta,” both of which measure a material or structure's ability to dissipate energy and thus to damp vibrations that otherwise would be radiated from the structure as unwanted sound, or noise. Determining the optimum materials from which to fabricate the cones and domes of speakers to provide the efficient reproduction and the highest signal-to-noise ratio for a given frequency band, sensitivity, and acoustic output level has long been the quest of loudspeaker designers.

In recent years, “flat diaphragm” or “flat panel” radiators have gained in popularity. The term “flat” is used in a relative sense to indicate that the diaphragm is no longer the typical cone speaker, which is roughly as deep as its diameter. Flat panel sound radiators discussed herein retain a thickness on the order of a few millimeters for a radiating area on the order of one half square meter or less. In alternative embodiments, this may be scaled up to a larger thickness for radiating areas, for example, of one half-meter square or greater. Flat panel sound radiators may employ multiple thinner diaphragms, in alternative embodiments, or be scaled downward for smaller radiators, perhaps of the order of one tenth of a square meter or less. Flat here excludes loudspeakers utilizing polymer film diaphragms, using electrodynamic or electrostatic generation of motive force, as well as those loudspeakers that use the diaphragm itself as the voice coil (“ribbons”) or those speakers using piezo-electric generation of mechanical force.

Flat panel sound radiators generally include a flat resonant panel that is excited or driven by an electromechanical transducer or exciter to vibrate the panel to produce sound. The exciter often is mounted directly to the back side of the panel and, when provided with audio frequency signals from an audio amplifier, transmits the resulting mechanical vibrations to the panel. Flat panel sound radiators have many beneficial uses such as, for example, installation in the grid of a suspended ceiling system in place of a traditional ceiling panel as a component of a sound distribution system in a building.

Much research and development has been devoted to the development of flat panel sound radiators by companies such as New Transducers Limited of Great Britain, also known as NXT, and Dai-Ichi of the Philippines. Numerous patents directed to various aspects of flat panel sound radiator technology have been issued to NXT, SLAB, BES, Sound Advance, and others, and the disclosures of such patents are hereby incorporated by reference as if fully set forth herein.

Unlike traditional cone and dome speakers, which produce sound largely through pistonic motion of speaker cones, there is a certain class of flat panel sound radiators that reproduce sound by a mechanism known as “distributed mode” reproduction. Flat panel sound radiators are thus sometimes knows as distributed mode radiators. Generally in such radiators, an exciter, which typically is of the traditional electro-dynamic voice-coil and magnet type, but may also be a piezo ceramic element, is operatively coupled to a flat panel radiator at a specific location. When provided with audio frequency signals from an amplifier, the exciter imparts localized vibrational bending to the panel at acoustic frequencies. These bending mode vibrations propagate or are distributed through the panel from the location of the exciter towards and perhaps to the edges of the panel. Bending waves propagate through the panel, typically with the wave speed varying with frequency. The shape of the expanding wave front that moves away from the location of the exciter is not necessarily preserved as a smoothly expanding series of circularly concentric waves, as they would in an idealized conventional cone speaker. Various bending modes are excited within the structure of the panel, which in part depend on the boundary conditions at the edge of the panel as well as the physical shape of the panel (square panels vibrate differently than circular, rectangular, or elliptical panels). In addition, shape can be manipulated to emphasize the interleaving of appropriate bending modes. The various resonant modes of vibration spread throughout the panel, and couple acoustically to the surrounding air to reproduce the sounds of an audio program in a fundamentally non-pistonic manner.

Among the problems with flat panel sound radiators to date has been that they have had inherently low signal-to-noise ratios such that the quality of the sound they produce has been relatively low. While this has not been a concern when flat panel sound radiators are used in certain low end applications such as computer speakers, it has made flat panel sound radiator technology unsatisfactory for higher end or audiophile speaker systems where high signal-to-noise is required. Further, the flat diaphragms of prior art flat panel sound radiators generally have not been able to exhibit large excursions, which has resulted in poor bass response and relatively low volume limits. In large measure, these limitations have resulted from the poor choice of materials from which the diaphragms of flat panel sound radiators have been made. These include the materials of the honeycomb cores of the panels, the materials of the facing skins, and the adhesives with which these elements are glued together. This problem and its solution are discussed in detail in our co-pending U.S. patent application entitled “Flat panel sound radiator with Enhanced Audio Properties,” the disclosure of which is hereby incorporated by reference as if fully set forth herein and is referred to hereinafter as the “incorporated disclosure.” Generally, however, the solution is to select materials with optimized physical and audio properties, such as flexibility, tensile strength, Young's modulus, tan delta, and low self noise, which results in a flat panel sound radiator with drastically improved signal-to-noise ratios and bass response.

Another problem with prior art flat panel sound radiators is that they have not been upwardly scalable to larger sizes necessary for use as, for instance, theatre or commercial speaker systems. This has been due to a variety of problems in addition to the generally poor sound quality and volume limits of prior art flat panel sound radiators discussed above. For instance, in order to scale up a prior art flat panel sound radiator to reproduce high volumes and/or good bass, a larger exciter with a heavy magnet structure is required to impart the necessary high excursions to the panel. In the past, exciters of flat panel sound radiator systems generally have been mounted directly to the panels themselves. Such an approach is not feasible when scaling up to larger heavier exciters for a variety of reasons. For instance, a heavy exciter mounted to the panel acts as an acoustic damper that impedes the reproduction of sound by the panel. Further, the greater weight causes the panel to droop when mounted horizontally and torques the panel when it is mounted vertically. During shipment, a heavy exciter mounted directly to the panel can damage the panel or shear off from the panel entirely.

Another hurdle to scaling up traditional flat panel sound radiators relates to the fact that producing high volume levels and/or good bass response necessarily requires that the panel be driven (by a heavier exciter) more aggressively to produce greater lateral excursions in the panel. At some point, however, the resulting degree of bending, flexing, and wave mechanical motion in the panel, which are characteristic of distributed mode reproduction, approaches the elastic limits and tensile strength of the panel materials and the adhesives that bind them together. As the panel is driven beyond these limits, the material of the panel begins to fracture and deform and the adhesives that mount the panel components together begin to fail. As a result, the panel itself is damaged or destroyed and its usefulness as a sound reproducer is ruined. Even if the panel maintains its mechanical and physical integrity, when it is driven beyond its elastic limits, it no longer responds to increasingly aggressive input from the exciter. This results in a mechanical clipping effect that distorts the reproduced audio and limits the volume and low frequency response capabilities of the radiator.

A further problem encountered in scaling up prior art flat panel sound radiators results from the increased size and mass of the voice coil in a larger exciter. As a voice coil is made larger by increasing the number of windings and/or the gauge of the wire in them, the impedance of the coil increases, particularly at higher frequencies. Further, the mass and inertia of the coil naturally increases as do eddy currents induced in the coil windings and surrounding conducting structures due to the movement of the coil within a magnetic field. All of these effects tend to reduce the efficiency of the exciter at higher frequencies resulting in a high frequency response roll-off. Thus, as the exciter structure is scaled up to produce greater excursions in the panel required for higher volumes and better bass response, the high frequency response of the radiator tends to degrade proportionally. Mounting multiple exciters (i.e. a low and a high frequency exciter) to the panel has been suggested, but this brings its own set of problems including interference and other effects that can degrade the quality of the reproduced audio from the panel.

For at least the forgoing reasons, successful scale-up of flat panel sound radiator systems has heretofore been an elusive objective for speaker system designers. A need exists nonetheless for an improved upwardly scalable flat panel sound radiator that is capable of quality audio reproduction at high volume levels (i.e. that has high power handling capability) and that exhibits exceptional frequency response, sensitivity, longevity, and durability. It is to the provision of such a flat panel sound radiator that the present invention is primarily directed.

### SUMMARY OF THE INVENTION

Briefly described, the present invention comprises an improved flat panel sound radiator system that is upwardly scaled for high power handling capability to reproduce audio programs at high volume levels, that exhibits good frequency response throughout the audible spectrum, that has good sensitivity and thus good efficiency, and that exhibits a high signal-to-noise ratio. The radiator system is thus usable to provide the advantages of flat panel distributed mode sound reproduction in high end or pro audio applications such as in theaters and audiophile sound systems, where flat panel sound radiators have heretofore been unacceptable.

The radiator system of the invention includes a flat panel sound radiator that is constructed of carefully selected materials and adhesives as described in detail in the incorporated disclosure referenced above. Thus, the panel exhibits naturally good sound quality and a high signal-to-noise ratio. The exciter of the system, which is a heaver motor structure akin to that in a traditional high quality loudspeaker, is mounted and supported on a support structure or “bridge” that spans the panel on its back side. The weight of the exciter is supported not by the panel itself, but rather by the bridge and the panel interacts with the exciter only through a voice coil assembly. This relieves the panel of the stress of supporting the exciter, eliminates the mass of the exciter that acts to damp movement of the panel, and allows the exciter to be designed with a practically unlimited magnet structure size to drive the panel as intensely as required.

A rigid frame, preferably but not necessarily made of metal, extends around the periphery of the panel. The bridge is secured at its ends to the frame. Thus, the bridge is isolated from the panel. However, the panel is not fixed to the frame as in prior art flat panel sound radiators and therefore is not mechanically clamped about its periphery. Instead, the periphery of the panel is coupled to the frame through a compliant rectangular surround that is similar in some respects to the compliant surround in a conventional cone-type loudspeaker. The surround may be made of any appropriate flexible compliant material and preferably, but not necessarily, is formed of a rubber such as butyl rubber or Santoprene, which is a blend of polypropylene and vulcanized rubber particles. The compliant surround can be configured with any of a variety of cross-sectional shapes including, but not limited to, a U-shape, a W-shape, or an accordion shape. In a square or rectangular flat panel sound radiator such as a flat panel sound radiator for installation in a suspended ceiling grid, each peripheral edge of the panel is coupled to the frame with a linear extruded surround, while other shaped surrounds obviously are appropriate for panels of other shapes.

The compliant surround provides a mechanical transition between pure distributed mode sound reproduction at lower volume levels (i.e. smaller excursions) and a composite distributed mode and pistonic mode reproduction at higher volume levels (i.e. larger excursions). More specifically, as the volume is increased, the exciter imparts larger and larger vibrational motion to the panel. At some point, the panel begins to approach its elastic limits where it cannot flex further without damage. At or just before this point, however, the compliant surround of the present invention begins to allow the entire panel to move in a fundamentally pistonic fashion within its frame in response to increasing input from the exciter. Thus, at higher volume levels, the panel responds to input from the exciter as a “floppy piston” with a portion of the sound being reproduced through distributed mode reproduction and a portion being reproduced through pistonic motion of the panel. The result is a flat panel sound radiator that can reproduce sound requiring panel excursions far greater than the limits imposed by pure distributed mode reproduction (i.e., reproducing high volume levels or deep bass).

In order to insure that high frequency response of the radiator is not degraded unacceptably by the extra mass and increased impedance of the larger voice coil structure, or the increased eddy currents created by movement of the voice coil in a more intense magnetic field, the present invention includes an exciter structure incorporating an underhung voice coil topology. To decrease the high frequency degradation further and shift the onset of high-frequency roll-off up an octave or so, the exciter also preferably incorporates other features such as, for example, a copper cap over the pole piece and/or an aluminum shorting ring to reduce eddy currents. Other measures to reduce the inductance of the voice coil may include the use of aluminum wire or copper-clad aluminum wire instead of copper wire to reduce the mass of the voice coil and/or winding said voice coil on edge (“flat” or “ribbon” wire).

The preferred embodiment includes an exciter incorporating a copper clad aluminum flat wire coil with a copper pole piece cap and shorting ring in conjunction with an underhung voice coil topology. The ultimate result is a flat panel sound radiator with a large exciter for producing the large excursions of high volume and extended low frequency reproduction while the high frequency roll-off characteristic of larger magnet and voice coil structures is minimized.

Thus, an improved flat panel sound radiator system is now provided that successfully addresses the problems and shortcomings of the prior art. The system has low self noise, a high signal-to-noise ratio, and good bass response because of the careful materials selection and construction of the panel. In addition, the system is upwardly scalable to provide high power handling capability, high excursion for good bass response and high volume levels, and extended high frequency response. Accordingly, the system is suitable for use in commercial pro audio and high end audio applications where flat panel sound radiators heretofore have not been acceptable. These and other features, objects, and advantages of the invention will be better appreciated upon review of the detailed description set forth below when taken in conjunction with the accompanying drawings, which are briefly described as follows.

### BRIEF DESCRIPTION OF THE DRAWINGS

FIG. 1 is a perspective view of a flat panel sound radiator system that embodies principles of the invention in a preferred form.

FIG. 2 is a cross sectional view of the radiator system of FIG. 1 taken along A-A of FIG. 1 and illustrating a preferred configuration of the various components of the system.

### DETAILED DESCRIPTION OF THE PREFERRED EMBODIMENTS

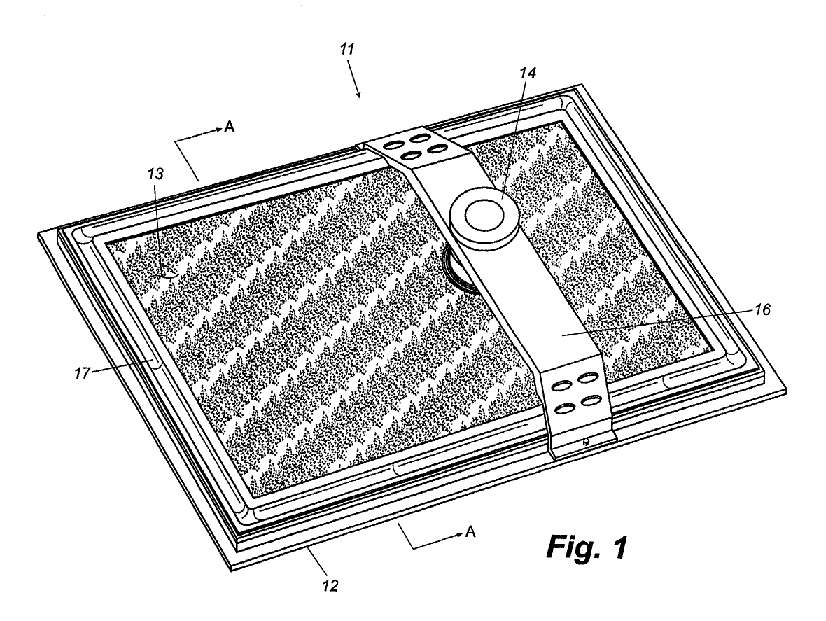

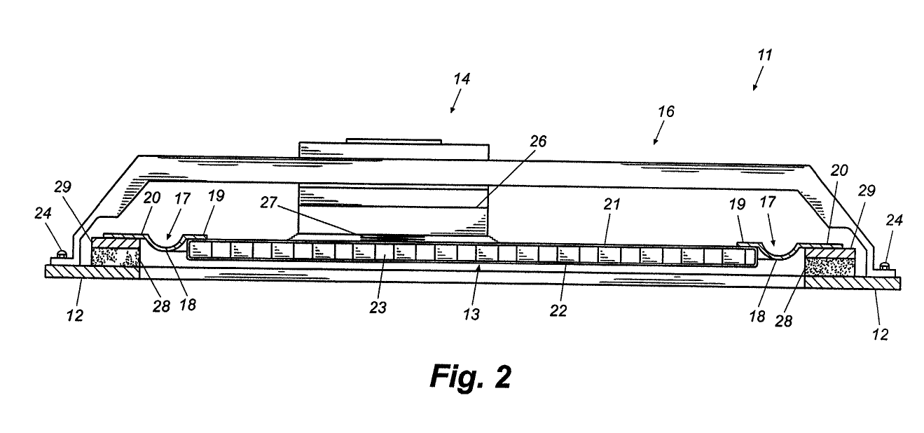

FIGS. 1 and 2 illustrate a flat panel sound radiator system that embodies principles of the present invention in one preferred form. It will be understood that the radiator system may take on any of a number of sizes and shapes according to the intended end use of the system. For example, in flat panel sound radiators for installation within an opening of a suspended ceiling grid, the panel may be mounted within a rectangular metal frame, which supports the edges of the radiator panel and provides a support for a sound transmitting (acoustically transparent) grill that covers the panel and that may be made to look like the exposed surfaces of surrounding ceiling panels within the grid. The invention will be described herein primarily in terms of such a suspended ceiling mounted flat panel sound radiator. It will be understood, however, that the invention is not limited to such a configuration.

Referring to FIGS. 1 and 2, the radiator system 11 comprises a rectangular metal frame 12 sized to fit and be supported within an opening of a suspended ceiling grid. A flat panel radiator 13 is disposed within and surrounded by the frame 12 and is constructed from carefully selected materials and adhesives to provide low self noise and a high signal-to-noise ratio when reproducing an audio program, all as described in detail in the incorporated disclosure. The peripheral edge of the flat panel radiator 13 is coupled to the frame 12 and supported by a compliant surround 17, which generally is similar to the compliant surround of a traditional cone-type loudspeaker. The compliant surround supports the edges of the flat panel radiator but also allows the entire panel to move laterally with respect to the frame when necessary to produce the large excursions of low bass frequencies and/or high volume levels.

A rigid bridge 16, which may be made of metal or another appropriate material, is mounted at its ends to opposite legs of the frame 12 and extends across, and is spaced from, the back side of the flat panel radiator 13. An electromechanical motor or exciter 14 is mounted to and supported by the bridge 16 and is operatively coupled to the flat panel radiator through a bobbin and voice coil assembly 27 (FIG. 2). Since the entire weight of the exciter 14 is supported by the bridge, which, in turn, transfers the weight to the metal frame 12 and ultimately to the grid of a suspended ceiling, the flat panel radiator 13 is not damped, torqued, or otherwise distorted in shape by the weight of the exciter. Furthermore, the exciter can now be made with a much more massive magnet structure to drive the flat panel radiator to the larger lateral excursions that are required to reproduce an audio program at high volume and/or to reproduce deep low bass frequencies.

Referring in more detail to FIG. 2, which illustrates the radiator system of this invention in more detail, the frame 12 is seen to extend generally around the flat panel radiator 13. The radiator 13 itself is constructed according to the detailed discussions in the incorporated disclosure to exhibit a high signal-to-noise ratio and enhanced frequency response. Generally, the radiator 13 has a core 23, which preferably is a honeycomb structure core, sandwiched between a pair of facing skins 21 and 22. The facing skins are adhered to the core with adhesive to form the completed radiator panel. The materials of the core and facing skins and the adhesives used to bond them together are carefully selected, as described in the incorporated disclosure, to exhibit low self noise, enhanced bass response, high damping, and durability.

An isolation gasket 28, which may be made of foam or another appropriately compliant material, is secured to and extends around the interior peripheral edge portion of the frame 12. An attachment rim 29, which may be fabricated of metal, plastic, or another relatively rigid material, is secured atop the isolation gasket with adhesive.

A compliant surround 17 extends around and supports the peripheral edge of the flat panel radiator 13. The surround is fabricated from a compliant flexible material such as, for example, a rubber such as butyl rubber or Santoprene, which is a blend of polypropylene and vulcanized rubber particles. The surround 17 has an inner leg 19, an outer leg 20 and a central portion 18. The inner leg 19 of the surround is secured with an appropriate adhesive to, and extends along, the peripheral edge portion of the flat panel radiator 13. The outer leg 20 of the surround is secured with an appropriate adhesive to the attachment rim 29. In the illustrated embodiment, the central portion 18 of the compliant surround is generally U-shaped. However, it also may take on other shapes such as, for example, a U-shape, W-shape or an accordion shape. In any event, it will be seen that the peripheral edge of the flat panel radiator 23 is compliantly supported by the surround with the surround accommodating lateral excursions of the panel. In this regard, the surround 17 functions in a manner similar to the annular compliant surround of a traditional cone-type loudspeaker system.

The magnet structure of an electromechanical exciter 14 is secured to and supported by the bridge 16 and extends toward the flat panel radiator 13. A cylindrical bobbin and voice coil assembly 27 is securely mounted to the back of the panel 13 and extends into the gap of the magnet structure in the traditional way. Conventionally, electrical signals fed to the voice coil from an audio amplifier causes the voice coil to move within the magnetic field of the magnet structure. This, in turn, imparts local bending and lateral excursion to the panel for reproducing the audio program.

The internal construction and function of the exciter 14 is substantially traditional and need not be described in great detail here. Generally, however, as discussed above, increasing the size and mass of the exciter and its magnet to impart greater audio energy to the panel leads to certain problems, in particular the degradation of high frequency response due to increased impedance, eddy currents, and the like. In order to address these problems, the exciter of the present invention preferably incorporates a copper clad aluminum flat wire coil with a copper pole piece cap and shorting ring in conjunction with an underhung voice coil topology. In this way, the onset of high frequency roll-off can be raised an octave or so to mitigate the high frequency losses inherent in a more massive exciter.

The flat panel sound radiator system of this invention functions essentially as follows to reproduce sound that requires high excursions, such as high volumes and bass frequencies. As an audio program at low volume levels is fed to the radiator system, local flexing is induced in the flat panel radiator by the exciter. These bending mode vibrations propagate or are distributed through the panel from the location of the exciter towards and perhaps to the edges of the panel. Bending waves propagate through the panel typically with the wave speed varying with frequency. The shape of the expanding wave front that moves away from the location of the exciter is not necessarily preserved as a smoothly expanding series of circularly concentric waves, as they would in an idealized conventional cone speaker. Various bending modes are excited within the structure of the panel.

As the volume of the audio program and the consequent excursion of the panel increases, the elastic limits of the core, adhesive joints, and skin of the panel are approached. At the elastic limit, the panel itself begins to resist any further flexing in response to increased input from the exciter. However, with the present invention, as the elastic limits within the panel are approached, the compliant surround provides a mechanical transition or crossover from purely distributed mode reproduction to a combination of pistonic and distributed mode reproduction. The panel in essence becomes a “floppy piston” with sound corresponding to excursions below the elastic limits of the panel (i.e. lower volumes and low level bass) being reproduced by distributed mode reproduction and sound corresponding to larger excursions being reproduced by pistonic reproduction, wherein the entire panel vibrates as a piston supported by the compliant surround. Thus, the panel can be driven to volume levels and bass content far beyond that allowed by the elastic limits of panel itself.

The invention has been described herein in terms of preferred embodiments and methodologies that represent the best mode known to the inventors of carrying out the invention. It will be obvious to those of skill in the art, however, that various additions, deletions, and modifications may be made to the illustrated embodiments without departing from the spirit and scope of the invention as set forth in the claims.

What is claimed is:

1. A flat panel sound radiator assembly comprising:
a frame;
a flat panel radiator disposed within said frame; said flat panel radiator having a front face and a back face;
a voice coil mounted to said back face of said flat panel radiator;
a support structure secured to said frame and being disposed in spaced relationship to said back face of said flat panel radiator; and
a magnet structure having a voice coil gap mounted on and supported by said support structure;
said voice coil extending into said voice coil gap for imparting vibrational movement to said flat panel radiator.

2. A flat panel sound radiator assembly as claimed in claim 1 and wherein said flat panel radiator has peripheral edges adjacent said frame and further comprising a compliant surround coupling said peripheral edges of said flat panel radiator to said frame to accommodate pistonic motion of said flat panel radiator.

3. A flat panel sound radiator assembly as claimed in claim 2 and wherein said compliant surround is made of a rubber material.

4. A flat panel sound radiator assembly as claimed in claim 3 and wherein said compliant surround is made of butyl rubber.

5. A flat panel sound radiator assembly as claimed in claim 3 and wherein said compliant surround is made of Santoprene®.

6. A flat panel sound radiator assembly as claimed in claim 2 and wherein said compliant surround has an inner leg attached to said flat panel radiator, an outer leg attached to said frame, and a central portion between said inner and outer legs.

7. A flat panel sound radiator assembly as claimed in claim 6 and wherein said central portion is substantially U-shaped.

8. A flat panel sound radiator assembly as claimed in claim 6 and wherein said central portion is substantially W-shaped.

9. A flat panel sound radiator assembly as claimed in claim 6 and wherein said central portion is substantially accordion-shaped.

10. A flat panel sound radiator assembly as claimed in claim 2 and wherein said flat panel radiator comprises a core sandwiched between facing skins.

11. A flat panel sound radiator assembly as claimed in claim 10 and wherein said core is a honeycomb core.

12. A flat panel sound radiator assembly as claimed in claim 11 and wherein said facing skins are made of a material with relatively low self noise and relatively high Young's modulus and tan delta.

13. A flat panel sound radiator assembly as claimed in claim 12 and wherein said facing skins are made of an aramid polyamide material.

14. A flat panel sound radiator assembly as claimed in claim 13 and wherein said facing skins are made of a material selected from the group consisting of Nomex®, Kevlar®, Conex®, and Technora®.

15. A flat panel sound radiator assembly as claimed in claim 14 and wherein said honeycomb core is made of Kraft paper.

16. A flat panel sound radiator assembly comprising:
a frame;
a flat panel radiator having peripheral edges, an inside face, and an outside face, said flat panel radiator being disposed in said frame;
a compliant surround coupling said peripheral edges of said flat panel radiator to said frame;
a support structure mounted to said frame and being disposed adjacent to and spaced from said inside face of said flat panel radiator;
an exciter mounted to said support structure adjacent said inside face of said flat panel radiator; and
a coupler for coupling said exciter to said flat panel radiator for inducing vibrational motion in said flat panel radiator for the reproduction of sound;
said flat panel radiator producing sound substantially through distributed mode reproduction below a sound level, said compliant sound accommodating the production of sound through pistonic mode reproduction above the sound level threshold.

17. A flat panel sound radiator assembly as claimed in claim 16 and wherein said exciter is a magnet structure and wherein said coupler is a voice coil mounted to said flat panel radiator and extending into a voice coil gap of said magnet structure.

18. A flat panel sound radiator assembly as claimed in claim 16 and wherein said flat panel radiator has a core sandwiched between facing skins, the material of said core and said facing skins being pre-selected such that said flat panel radiator exhibits a signal-to-noise greater than 40 dB for an 85 dB input signal within a frequency range between 1 kHz and 10 kHz.

19. A flat panel sound radiator assembly as claimed in claim 18 and wherein said compliant surround is made of a rubber material.

20. A flat panel sound radiator assembly as claimed in claim 19 and wherein said compliant surround is generally U-shaped.

21. A flat panel sound radiator assembly as claimed in claim 19 and wherein said compliant surround is generally W-shaped.

22. A method of enhancing the power handling capacity of a flat panel sound radiator having a flat panel radiator with peripheral edges disposed within a frame and activated by an exciter to reproduce sound, said method comprising the steps of supporting the exciter on a support structure spaced from the flat panel radiator and coupling the peripheral edges of the flat panel radiator to the frame with a compliant surround such that lower volume sound is reproduced substantially by distributed mode reproduction within the flat panel radiator and higher volume sound is reproduced substantially by pistonic mode reproduction of the flat panel radiator accommodated by the compliant surround.

23. The method of claim 22 and wherein the exciter is a magnet structure having a voice coil gap and further comprising the step of securing a voice coil to the flat panel radiator, the voice coil extending into the voice coil gap of the magnet structure.

24. The method of claim 22 and wherein the flat panel radiator and the frame are substantially rectangular, the compliant surround being substantially straight extrusions extending between the peripheral edges of the flat panel radiator and the frame.

25. A flat panel sound radiator assembly comprising a frame, a flat panel radiator disposed in said frame and having peripheral edges spaced from said frame, an exciter supported on a support structure spaced from said flat panel radiator, said exciter for imparting audio frequency vibrational motion to said flat panel radiator, and a compliant surround movably coupling at least a portion of said peripheral edges of said flat panel radiator to said frame to accommodate pistonic movement of said flat panel radiator above a predetermined sound level threshold to permit said flat panel sound radiator assembly to reproduce sound at higher volume levels.
